(19) United States
(12) Patent Application Publication
(10) Pub. No.: US 2003/0069837 A1
(43) Pub. Date: Apr. 10, 2003

(54) Method and apparatus for clearing automobile contracts

(76) Inventors: Timothy J. Mills, Carol Stream, IL (US); Daniel Tom, Streamwood, IL (US)

Correspondence Address: BUCKLEY, MASCHOFF, TALWALKAR, & ALLISON, 5 ELM STREET, NEW CANAAN, CT, 06840, US

(21) Appl. No.: 09/970,958

(22) Filed: Oct. 4, 2001

(51) Int. Cl. G06F 17/60; H04K 1/00; H04L 9/00

(52) U.S. Cl. 705/38; 705/37

(57) ABSTRACT

A system, method, means, apparatus, and computer program code for clearing an automobile contract where a dealer has or will be providing financing to a purchaser of the automobile. According to embodiments of the present invention, one or more contract parameters for sale of an automobile are established or otherwise determined. Once at least one contract parameter is determined or established, a dealer or another party one behalf of the dealer, may auction the contract among one or more lenders. A lender may be notified of a contract available via auction by receiving a communication (e.g., email message, telephone call) regarding the contract. Once a winning bid for a contract is determined, the dealer or party conducting the auction may notify the winning lender, automobile purchaser, etc. Also, a dealer may sell the contract to the lender in accordance with the lender's winning bid.

### BACKGROUND OF THE INVENTION

1. Field of the Invention

The present invention relates to a method and apparatus for clearing automobile contracts and, more particularly, embodiments of the present invention relate to methods, apparatus, and computer program code for placing automobile contracts for auction.

2. Discussion of the Prior Art

In most situations, when a prospective customer enters an automobile dealer's lot, the automobile dealer will work very hard to sell or lease the customer an automobile. A dealer may provide financing to the customer in order to provide the customer the financial means and opportunity to purchase the automobile. Thus, the dealer will provide a loan, lease or other financing to the customer, usually after initiating or conducting a credit check for the customer. The financing or lease contract will require the customer to make payments to the dealer pursuant to the terms of the contract. Since a typical dealer is not in the business of maintaining a portfolio of automobile financing or lease contracts, the dealer will then sell the financing and lease contracts in a secondary market to one or more lenders and lessors willing to take over the financing and lease contracts. After providing financing or leasing to the customer via a financing or lease contract, the dealer will contact one or more lenders or lessors and offer the lenders or lessors an opportunity to purchase the financing or lease contract. Generally, the lender or lessor will pay the price or remaining balance of the automobile to the dealer, and may also provide a flat or single payment to the dealer, as compensation to the dealer for the lender or lessor purchasing the financing or lease contract from the dealer. The customer will then make payments to the lender or lessor as opposed to the dealer.

Unfortunately, the dealer must enter into a financing or lease contract with a customer without a prior binding commitment from a lender or lessor to purchase the financing or lease contract. Moreover, the dealer does not always get the best price for the financing or lease contract when selling the financing or lease contract directly to a lender or lessor. From a lender's and lessor's perspective, the dealer does not provide the lender and lessor with complete specific information related to the financing or lease. That is, the information provided by a dealer to the lender and lessor includes only a credit report for the customer, but does not include adequate information regarding the asset (e.g., the automobile) being purchased or leased, the quality of the asset as collateral, the position of the asset (i.e., is the asset in a negative equity position or a positive equity position), the cash flow or stream (e.g., number and amount of payments) involved in the financing or lease, etc.

### BRIEF SUMMARY OF THE INVENTION

Embodiments of the present invention provide a system, method, means, apparatus, and computer program code for clearing one or more automobile contracts via auction. An automobile contract may be or include a financing contract associated with the sale of one or more automobiles by a dealer or group of dealers. Alternatively, an automobile contract may be or include a lease between a customer and a dealer that obligates the customer to make payments to the dealer and return the automobile at the end of the lease term. According to embodiments of the present invention, one or more contract parameters involving an automobile contract are established or otherwise determined. Such parameters may form part of a financing contract executed between a dealer and a purchaser of an automobile or part of a lease between a dealer and a lessee of an automobile.

In some embodiments, an automobile contract parameter may include information related to the automobile itself, including, but not limited to, the condition or quality of the automobile, a purchaser's equity position in the automobile, etc. In some embodiments, a contract parameter also may include information regarding a cash stream generated by the financing or lease arrangement for the automobile. For example, a contract parameter may include information regarding length of a financing or lease period, payments to be made during the financing or lease period, the interest rate for the financing, the amount of the financing, etc.

Once at least one contract parameter is determined or established for an automobile contract, a dealer or another party on behalf of the dealer, may auction the automobile contract among one or more lenders or other parties (collectively referred to herein as “lenders”). In some embodiments, a dealer may establish a dealer filter to limit the number, type, etc. of lenders that can bid on a particular contract. Similarly, in some embodiments, a lender may establish a lender filter that may indicated one or more requirements (automobile price, financed amount, purchaser credit rating) a contract must have before the lender will be interested in or bid on the contract. In some embodiments, a lender may be notified of a contract available via auction by receiving a communication (e.g., email message, telephone call) regarding the contract. In other embodiments a lender may be notified of a contract available via auction by visiting a World Wide Web (“Web”) site, electronic directory, listing or database that contains information regarding the contract. Once a winning bid for a contract is determined, the dealer or party conducting the auction may notify the winning lender, automobile purchaser, etc. Also, a dealer may sell the contract to the lender in accordance with the lender's winning bid, receive payment from the lender for the contract in accordance the lender's winning bid, etc.

In some embodiments, a dealer and a lender may establish a relationship such that the lender may bid on multiple automobile contracts auctioned by the dealer and use one or more bids made by the lender for contracts in excess of minimum amounts required by the dealer as credit for use with one ore more bids made by the lender for other contracts that are less than the minimum amounts for the bids required by the dealer. Thus, the dealer and lender work together to form a “bank” of excess funds created by one or more bids made by the lender for automobile contracts for use with one or more other bids by the lender for other contracts.

According to embodiments of the present invention, a method for clearing an automobile contract may include determining at least one parameter for a contract associated with financing provided by a first party to a second party regarding an automobile; auctioning the contract such that the first party sells the contract; and notifying at least one party of a winning bid for the contract. In another embodiment, a method for clearing an automobile contract may include receiving data from a party, the data being indicative of at least one parameter for an automobile contract; auctioning the automobile contract; and notifying the party of a wining bid for the automobile contract. In a further embodiment, a method for clearing an automobile contract may include determining at least one parameter for at least one automobile contract; applying at least one dealer filter; providing a notification to at least one lender regarding an opportunity to bid on the at least one automobile contract, wherein the notification includes data indicative of the at least one parameter for the at least one automobile contract; receiving a bid from the at least one lender regarding the at least one automobile contract; and determining a winning bid for the at least one automobile contract. In a still further embodiment, a method for selling an automobile contract may include receiving at least one parameter for at least one automobile contract; applying at least one lender filter; providing a notification to at least one lender regarding an opportunity to bid on the at least one automobile contract, wherein the notification includes data indicative of the at least one parameter; receiving a bid from the at least one lender regarding the at least one automobile contract; determining a winning bid for the at least one automobile contract; and notifying at least one party regarding the winning bid.

According to embodiments of the present invention, a system for facilitating clearance of automobile contracts may include a memory; a communication port; and a processor connected to the memory and the communication port, the processor being operative to determine at least one parameter for a contract associated with financing provided by a first party to a second party regarding an automobile; auction the contract such that the first party sells the contract; and notify at least one party of a winning bid for the contract. In another embodiment, the processor may instead be operative to receive data from a party, the data being indicative of at least one parameter for a an automobile contract; auction the automobile contract; and notify the party of a wining bid for the automobile contract. In a further embodiment, the processor may instead be operative to determine at least one parameter for at least one automobile contract; apply at least one dealer filter; provide a notification to at least one lender regarding an opportunity to bid on the at least one automobile contract, wherein the notification includes data indicative of the at least one parameter for the at least one automobile contract; receive a bid from the at least one lender regarding the at least one automobile contract; and determine a winning bid for the at least one automobile contract. In a still further embodiment, the processor may instead be operative to receive at least one parameter for at least one automobile contract; apply at least one lender filter; provide a notification to at least one lender regarding an opportunity to bid on the at least one automobile contract, wherein the notification includes data indicative of the at least one parameter; receive a bid from the at least one lender regarding the at least one automobile contract; determine a winning bid for the at least one automobile contract; and notify at least one party regarding the winning bid.

According to embodiments of the present invention, a computer program product in a computer readable medium for facilitating clearance of automobile contracts may include first instructions for identifying at least one parameter for a contract associated with financing provided by a first party to a second party regarding an automobile; second instructions for placing the contract for auction; and third instructions for providing a notification to at least one party of a winning bid for the contract. In another embodiment, a computer program product in a computer readable medium for facilitating clearance of automobile contracts may include first instructions for obtaining data from a party, the data being indicative of at least one parameter for an automobile contract; second instructions for placing the automobile contract for auction; and third instructions for providing a notification to the party of a wining bid for the automobile contract. In a further embodiment, a computer program product in a computer readable medium for facilitating clearance of automobile contracts may include first instructions for identifying at least one parameter for at least one automobile contract; second instructions for filtering lenders that can bid on the automobile contract; third instructions for sending a notification to at least one lender regarding an opportunity to bid on the at least one automobile contract, wherein the notification includes data indicative of the at least one parameter for the at least one automobile contract; fourth instructions for obtaining a bid from the at least one lender regarding the at least one automobile contract; and fifth instructions for identifying a winning bid for the at least one automobile contract. In a still further embodiment, a computer program product in a computer readable medium for facilitating clearance of automobile contracts may include first instructions for obtaining at least one parameter for at least one automobile contract; second instructions for filtering lenders that can bid on the automobile contract; third instructions for sending a notification to at least one lender regarding an opportunity to bid on the at least one automobile contract, wherein the notification includes data indicative of the at least one parameter; fourth instructions for sending a bid from the at least one lender regarding the at least one automobile contract; fifth instructions for identifying a winning bid for the at least one automobile contract; and sixth instructions for sending a notification to at least one party regarding the winning bid.

According to one embodiment of the present invention, an apparatus for facilitating clearance of automobile contracts may include means for identifying at least one parameter for a contract for financing provided by a first party to a second party regarding an automobile; means for placing the contract for auction; and means for providing a notification to at least one party of a winning bid for the contract. In another embodiment, an apparatus for facilitating clearance of automobile contracts may include means for obtaining data from a party, the data being indicative of at least one parameter for an automobile contract; means for placing the automobile contract for auction; and means for providing a notification to the party of a wining bid for the automobile contract. In a further embodiment, an apparatus for facilitating clearance of automobile contracts may include means for identifying at least one parameter for at least one automobile contract; means for filtering lenders that can bid on the automobile contract; means for sending a notification to at least one lender regarding an opportunity to bid on the at least one automobile contract, wherein the notification includes data indicative of the at least one parameter for the at least one automobile contract; means for obtaining a bid from the at least one lender regarding the at least one automobile contract; and means for identifying a winning bid for the at least one automobile contract. In a still further embodiment, an apparatus for facilitating clearance of automobile contracts may include means for obtaining at least one parameter for at least one automobile contract; means for filtering lenders that can bid on the automobile contract; means for sending a notification to at least one lender regarding an opportunity to bid on the at least one automobile contract, wherein the notification includes data indicative of the at least one parameter; means for sending a bid from the at least one lender regarding the at least one automobile contract; means for identifying a winning bid for the at least one automobile contract; and means for sending a notification to at least one party regarding the winning bid.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a flowchart of a first embodiment of a method in accordance with the present invention;

FIG. 2 is a flowchart of a first embodiment of the auction contract step of the method of FIG. 1;

FIG. 3 is a flowchart of a second embodiment of the auction contract step of the method of FIG. 1;

FIG. 4 is a flowchart of a second embodiment of a method in accordance with the present invention;

FIG. 5 is a block diagram of system components for an embodiment of an apparatus usable with the methods of FIGS. 1-4;

FIG. 6 is a block diagram of components for a dealer device of FIG. 5;

FIG. 7 is an illustration of a representative contract information database of FIG. 6;

FIG. 8 is an illustration of a representative dealer information database of FIG. 6; and

FIG. 9 is an illustration of a representative lender information database of FIG. 6.

### DETAILED DESCRIPTION OF THE INVENTION

Applicants have recognized that there is a need for systems and methods that facilitate the clearance and sale of automobile contracts. Embodiments of the present invention provide such capabilities by enabling one or more dealers to sell via auction(s) one or more automobile contracts associated with leasing or financing of automobiles. In some embodiments, an automobile contract may be incorporated or included in a sales contract or a lease contract. The methods described herein may be offered as part of a fee-based service for or on behalf of one or more dealers and/or one or more lenders. That is, in some embodiments, a party may conduct the auction process for a dealer and receive compensation from the dealer for during so. In addition, the party may receive compensation from a lender for allowing the lender to bid on automobile contracts or for allowing the lender to receive information regarding automobile contracts available via auction. These and other features will be discussed in further detail below, by describing a system, means, individual devices, and processes according to embodiments of the invention.

### Process Description

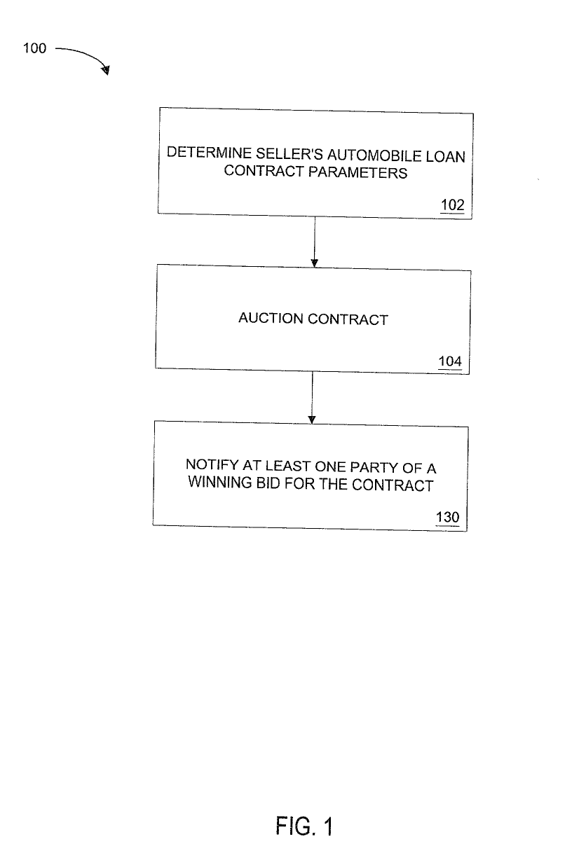

Reference is now made to FIG. 1, where a flow chart 100 is shown which represents the operation of a first embodiment of the present invention. The particular arrangement of elements in the flow chart 100 is not meant to imply a fixed order to the steps; embodiments of the present invention can be practiced in any order that is practicable. In some embodiments, some or all of the steps of the method 100 may be performed or completed by a server, user device and/or another device, as will be discussed in more detail below.

The method 100 is particularly well suited for implementation by a dealer or implementation by a device or entity on behalf of one or more dealers. In some embodiments of the method 100, a dealer may conduct an auction for an automobile contract itself. In other embodiments, a dealer may use another entity to conduct an auction for an automobile contract on behalf of the dealer. Thus, the method 100 may be implemented in at least three different ways. First, a dealer may implement the method 100 and conduct the auction itself. Second, another party may implement the method 100 and conduct the auction on behalf of one or more dealers. Third, a dealer may use another party to conduct an auction on behalf of the dealer while the dealer conducts other aspects of the method 100. These and other implementations of the method 100 will be discussed in further detail below. The method 100 also provides advantages to a lender buying or attempting to buy one or more automobile contracts as the method 100 provides the lender an opportunity to provide value to a dealer via means other than a price paid by the lender to the dealer to assume an automobile contract.

Processing begins at a step 102 during which one or more parameters for an automobile contract are identified or otherwise determined for a dealer or other automobile seller or lesser (hereinafter referred to as “dealer”). For purposes of the present invention, an “automobile” may be or include any car, truck, motorcycle, boat, or other form of transportation. In some embodiments, a dealer and a purchaser of an automobile may enter into a contract wherein the dealer provides a loan or other financing directly to the purchaser as part of the sale of the automobile from the dealer to the purchaser. Alternatively, the contract may be a lease between the dealer and a customer for the automobile. Thus, an automobile contract may be or include a financing contract associated with a sale of an automobile or a lease contract associated with a lease of an automobile. The contract may be a fully executed agreement or formal document signed by and between the dealer and the purchaser. Thus, contract parameters may be or include such things as the financing amount, interest and/or term, an identification of the collateral (usually the automobile being purchased) for the financing, the condition or quality of the collateral, the position of the asset (i.e., is the asset in a negative equity position or a positive equity position), the cash flow to the dealer (e.g., payment schedule, payment amounts) for financing provided by the dealer in the contract, the cash flow to the dealer under a lease, information regarding the automobile involved in the contract, information other than information regarding a purchaser of the automobile involved in the contract, information not found on a credit report or in a credit analysis of a purchaser or lessee of the automobile involved in the contract, etc. The dealer and the purchaser establish some or all of the financing parameters during the negotiation leasing process, or purchasing process and such parameters may be known to the dealer or formed as part of an executed contract between the dealer and the purchaser or lessee. Thus, in some embodiments, the step 102 or the method 100 may include determining a condition of an automobile; determining an equity position in an automobile by a purchaser of the automobile; determining a payment stream for financing or a lease associated with an automobile or automobile contract, etc.

In some embodiments, a contract parameter may be, include, and/or be limited to information regarding an automobile or other asset (i.e., the collateral) being purchased as part of the contract, information not found on a credit report, credit or financing application, etc. Thus, a contract parameter may provide information to a prospective lender that is not otherwise available to the lender when the lender is provided an opportunity to purchase an automobile contract.

In some embodiments, the method 100 might be used to allow a dealer to determine what financing the dealer may provide a potential purchaser of an automobile prior to the dealer actually selling the automobile. Thus, while a formal sale of the automobile has not yet occurred and an executed contract may not exist between the dealer and the purchaser, the dealer may want to offer a loan or other financing to the purchaser as part of an automobile contract knowing for certain that the dealer can sell the automobile contract to a lender in a secondary market. Thus, contract parameters in this embodiment may include some or all of the parameters discussed above, even though the dealer has not yet completed sale of the automobile, thereby providing the dealer with the ability to increase profit on the sale by writing the automobile contract at the most favorable terms to the dealer.

As illustrated by these previous two embodiments, a dealer may establish contract parameters in advance of a sale or lease of an automobile or as part of, or during, a sale or lease of an automobile. The dealer collects or otherwise determines the automobile contract parameters in either case as part of completing or implementing the step 102.

In other embodiments, a device or entity may conduct the method 100 for, or on behalf of, one or more dealers. In such embodiments, the device or entity may complete or implement the step 102 by receiving or retrieving the contract parameters directly or indirectly from a dealer that creates or identifies the contract parameters as part of completing a sale of an automobile or attempting to determine what financing terms to offer to a prospective purchaser of an automobile.

In some embodiments, any request, command, or other communication, data or notification described herein that may be sent or received by a dealer, lender, purchaser, auction conductor or any other party during any step of any method described herein, may be in any form or format, including, but not limited to, a HTTP (Hypertext Transfer Protocol), HTML (Hypertext Mark-up Language) or FTP (File Transfer Protocol) transmission, XML (Extensible Mark-up Language) feed, email message, instant message communication, facsimile or radio transmission, telephone call, electronic signal or communication, etc.

In some embodiments of the method 100, determining at least one parameter for a contract may include one or more of the following: establishing a default set of contract parameters, (e.g., minimum automobile condition, minimum automobile value, minimum equity position in automobile by purchaser of automobile), some or all of which may be used for multiple automobile contracts; receiving data indicative of at least one parameter; receiving information regarding at least one parameter from a dealer; receiving information regarding at least one parameter from a potential purchaser or lessee of an automobile; receiving information regarding at least one parameter from an actual purchaser or lessee of an automobile, etc.

During a step 104, the automobile contract is offered for sale via an auction. For example, the party may implement an auction oriented Web site to conduct auctions. Information on conducting an auction for a loan may be found in U.S. Pat. No. 5,996,669, all of which is incorporated herein by reference. Information on matching a loan to a borrower may be found in U.S. Pat. No. 5,940,812, all of which is incorporated herein by reference.

As previously discussed above, the method 100 may be implemented in at least three different ways. That is, a dealer may implement the method 100 and conduct the auction itself, another party may implement the method 100 and conduct the auction on behalf of one or more dealers, or a dealer may use another party to conduct an auction on behalf of the dealer while the dealer conducts other steps of the method 100.

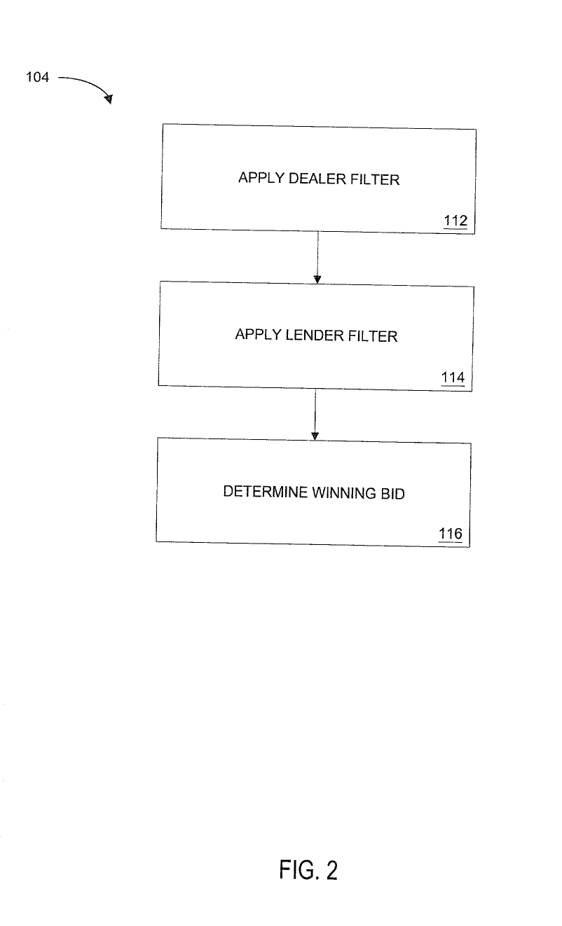

Now referring to FIG. 2, a dealer or other party implementing the method 100 and conducting an auction during the step 104 may implement several optional steps as part of the step 104. For example, in some embodiments, the dealer or other party conducting the step 104 may apply a dealer filter during a step 112 and/or a lender filter during a step 114.

A dealer filter may be or include one or more rules, procedures, heuristics, algorithms, selections, requirements, restrictions, etc. imposed by a dealer regarding a lender for a particular contract being auctioned. For example, a dealer may impose a filter for a particular automobile contract which requires lenders bidding on the contract to be in the same state as the dealer, requires lenders bidding on the contract to meet certain financial requirements, requires lenders bidding on the contract to have a satisfactory history or relationship with the dealer, requires lenders bidding on the contract to have preferred or qualified status, etc. In some embodiments, a dealer filter may include designation or identification of one or more specific lenders that will be allowed to bid on a particular contract and/or designation or identification of one or more specific lenders that will not be allowed to bid on a particular contract.

Dealer filter information may be included in or as part of contract parameters determined during the step 102. A dealer or other party may store, maintain, update, etc. dealer filter information as such information becomes available or is developed over time. In some embodiments, the step 104, the step 112, or the method 100 may include requesting, receiving, accessing, retrieving, storing, updating, etc. dealer filter information or other data. Information or other data indicative of a dealer filter be sent or received as in or as part of an email message, instant message communication, XML feed, FTP transmission or other electronic signal or communication. For example, a dealer may send an email message to a party conducting an auction for an automobile contract on behalf of the dealer, wherein the email message includes a list of one or more dealer requirements or conditions for lenders bidding on the contract. In some embodiments, dealer filter information may be stored in, and accessed from, a filter information database.

Similar to a dealer filter, a lender filter may be or include one or more rules, procedures, heuristics, algorithms, selections, requirements, restrictions, etc. imposed by a lender regarding a contract being auctioned or a dealer providing the contract for auction. For example, a lender may not be willing to bid on contracts exceeding a maximum threshold value established by the lender. As another example, a lender may require that a contract meet or exceed a minimum threshold value. As a further example, a lender may not be willing to bid on a contract from or sponsored by a particular dealer.

A dealer or other party may store, maintain, update, etc. lender filter information as such information becomes available or is developed over time. In some embodiments, the step 104, the step 114, or the method 100 may include requesting, receiving, accessing, retrieving, storing, updating, etc. lender filter information or other data. Information or other data indicative of a lender filter be sent or received as in or as part of an email message, instant message communication, XML feed, FTP transmission or other electronic signal or communication. For example, a lender may send an FTP transmission message to a dealer or other party conducting an auction for an automobile contract, wherein the FTP transmission includes data that describes one or more conditions that the contract must meet before the lender will bid on the contract or be interested in bidding on the contract. In some embodiments, lender filter information may be stored in, and accessed from, a filter information database.

As illustrated by the examples previously discussed above, in some embodiments the method 100 or the step 104 may include providing a notification of at least one parameter to a conductor of an auction for a contract and/or receiving information regarding a winning bid for the contract from the conductor of the auction. A contract parameter may be provided or communicated in any form or format

In other embodiments, the method 100 or the step 104 may include applying one or more dealer filters, applying one or more lender filters, sending or receiving information or other data regarding one or more dealer filters and/or one or more lender filters, etc. In some embodiments, the method 100 or the step 104 may include notifying one or more lenders regarding a contract available for auction which may include posting the contract information on a Web site for lenders to retrieve or download, emailing or otherwise transmitting the contract information to the lenders, etc. Also, in some embodiments, the method 100 or the step 104 may include receiving at least one bid from at least one lender regarding an auction, establishing a Web site for conducting an auction of an automobile contract, establishing password access to a Web site to allow one or more lenders to obtain information regarding a contract and/or to provide bids on a contract, etc.

In some embodiments, the method 100 or the step 104 may include notifying a lender and/or a dealer regarding receipt of the lender's bid, notifying a lender and/or dealer regarding the lender winning or losing an auction for a contract, providing a dealer and/or a potential or actual purchaser of an automobile of a winning bid for a contract and/or a winning lender, etc.

During a step 116, a dealer or other party conducting an auction determines a winning bid for a contract. The step 116, or some other part of the method 100, may include notifying one of more lenders of the availability of the contract to bid on, the bid parameters, etc. In some embodiments, a lender might not be notified of an opportunity to bid on a contract if the lender is excluded as a result of a dealer filter or a lender filter. The dealer may then receive bids from one or more lenders. In some embodiments, the dealer may operate one or more Web sites on which information regarding the contract being auctioned can be found or requested, bids can be made on the contract, etc. In some embodiments, a contract may be available for bid during a limited or specific period of time, require a minimum bid, etc. In some embodiments, the dealer or other party conducting an auction may provide significant information to lenders regarding the contract, automobile, etc. such that the lenders have considerable information on which to base their bids. As previously discussed above, in conventional approaches lenders do not receive information regarding the condition or position of the asset, the automobile financing or leasing terms, potential cash flow from a purchaser or lessee to a lender, etc. before agreeing to purchase an automobile contract from a dealer. Rather, the lenders are provided only with a credit application of the automobile purchaser, thereby making it difficult for the lenders to determine their best bids.

In some embodiments, the method 100 may include determining one or more requirements or minimum acceptable parameters for a bid made by a lender for a contract being or to be auctioned. For example, a bid may need to include certain information (e.g., lender name, address, prior history), a minimum bid (e.g., a minimum price to assume the contract), etc. A bid parameter also may include information regarding how bids made on a contract will be scored, ranked, etc. The step 104 may include receiving information regarding a bid requirement and/or communicating such bid requirement to one or more potential lenders that may bid on a contract. During the step 116, a dealer conducting an auction may determine a winning bid according to whatever bid parameters or other criteria has been established. If no bid is received for an automobile contract, a dealer or other party may adjust or delete a bid requirement to encourage bids or to make purchase of the automobile contract more attractive to lenders. If a lot of bids are received for an automobile contract, a dealer or other party may adjust or add a bid requirement to discourage bids or to make sale of the automobile contract more lucrative to the dealer or other party.

In some embodiments, a dealer or other party conducting an auction may implement password protected access or other security measures regarding contract and/or bid information. For example, a dealer or other party may conduct the auction via a Web site and provide lenders with passwords that allow the lenders, but no one else, to obtain access to the contract information, bid parameters, etc., to made bids, to check the status of an auction, to establish and automatic bidding rules used by the lender, etc. An automatic bidding rule may allow a lender to increase its bid automatically based on the action of other lenders bidding on a contract. For example, a lender may allow its bids to be increased by a fixed amount each time another lender increases its bid. The first lender also may establish a maximum point above which its bid cannot be increased without its approval.

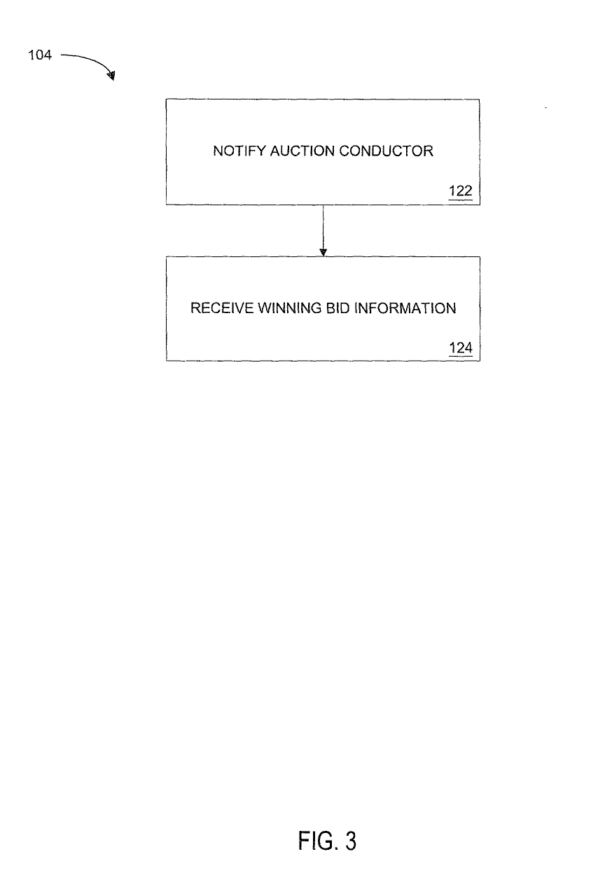

As previously mentioned above, in some embodiments of the method 100, a party may conduct an auction on behalf of a dealer or other automobile seller. Now referring to FIG. 3, a dealer using another party to conducting an auction my implement one or more optional steps as part of the step 104. For example, in some embodiments, the dealer may notify a conductor of the auction during a step 122 and may provide contract parameters, dealer and/lender filter information, bid requirements, etc. to the auction conductor. Presumably, the auction conductor will conduct the auction and determine a winner of the auction. During a step 124, the dealer receives a notification or other information regarding the winning bid, which may include detailed information of the winning bid, contact information for the lender, etc.

Referring once again to FIG. 1, during a step 130 a dealer or other party implementing the method 100 provides a notification to at least one party regarding the winning bid. In embodiments where a dealer is implementing the method 100, the dealer may notify the winning lender and/or an automobile purchaser or lessee during the step 130. In embodiments where a party is implementing the method 100 on behalf of a dealer, the party may notify the dealer, a winning lender, and/or an automobile purchaser or lesser during the step 130. The notification may include information regarding the winning lender, winning bid, financing parameters, dealer information, etc.

Once a winning bid for a contract is determined, accepted, etc., a dealer may sell the contract to a lender in accordance with the winning bid, receive payment from the lender for the contract in accordance the winning bid, etc.

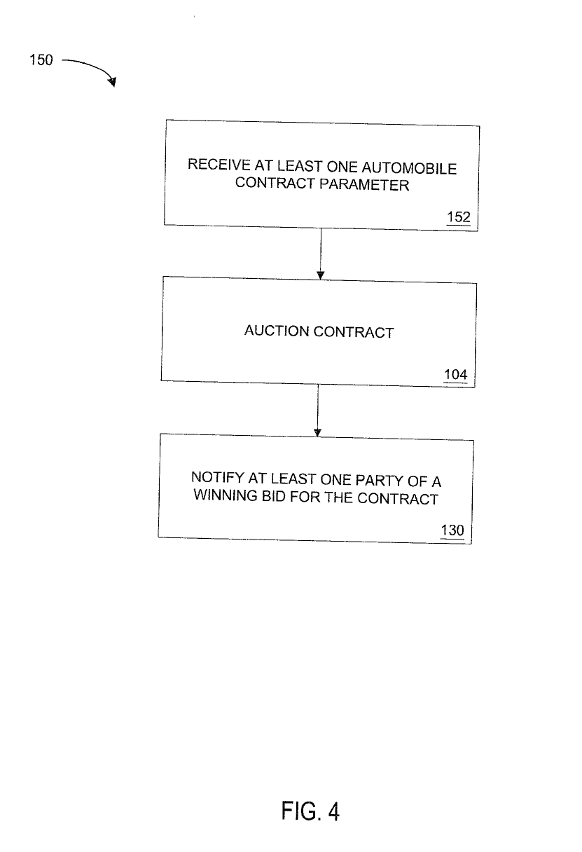

Now referring to FIG. 4, a second embodiment 150 of a method in accordance with the present invention is illustrated. The method 150 is particularly well suited for a party that conducts auctions for automobile contracts on behalf of one or more dealers. The method 150 includes the steps 104 and 130 as previously discussed above. In addition, the method 150 includes a step 152 during which the party receives at least one automobile contract parameter from a dealer. The parameter may be received as part of an electronic communication and may be in any form or format.

In some embodiments, the method 150 may include applying a dealer filter, applying a lender filter, receiving information regarding a dealer filter, receiving information regarding a lender filter, receiving at least one bid for a contract, notifying at least one lender of an opportunity to bid on a contract, establishing a Web site on which to conduct an auction for a contract, notifying a lender and/or a dealer of a winning bid for a contract, etc. In some embodiments, the method 150 may include some or all of the variations discussed above with regard to the method 100. Once a winning bid for a contract is determined, accepted, etc., a dealer may sell the contract to a lender in accordance with the winning bid, receive payment from the lender for the contract in accordance the winning bid, etc.

As another embodiment of the present invention, two or more contracts may be pooled and auctioned together or simultaneously. In such a situation, a dealer may be able to sell contacts having varying degrees of risk or attractiveness. The method's 100 and 150 are applicable to such a contract pooling embodiment and contract parameters for more than one contract may be determined during the step 102 or received during the step 152. Similarly, the remaining steps of the methods 100 and 150 may be modified accordingly to allow pools of two or more automobile contracts to be sold via auction.

In some embodiments, any of the methods disclosed herein may include selling and/or providing an automobile, conducting a credit check or credit analysis for a potential or actual purchaser of an automobile, ordering, processing or receiving a credit report for a potential or actual purchaser of an automobile, determining a credit analysis of a purchaser of the automobile, wherein the at least one contract parameter includes information not found on the credit report, etc.

In some embodiments, a party implementing any of the methods disclosed herein may aggregate and/or sell data regarding one or more dealers, one or more lenders, one or more winning or losing bids, one or more contracts, one or more contract parameters, etc. For example, a party may sell data indicating a profile of automobile purchasers, lessee, contracts, etc. and likely success rates or amount of profit. As another example, a dealer may want to obtain or generate information on customers that the dealer sells automobiles to and/or that the dealer fails to sell automobiles to so that the dealer can develop more successful strategies for dealing with potential customers, for offering or providing financing or leases to automobile purchasers, etc. Information regarding an automobile contracts performance over time may be monitored to provide dealers and lenders with additional information regarding the long term cost and rate of return of an automobile contract.

In some embodiments, a dealer and a lender, or a party or device on behalf of the dealer and lender, may work together over a series of automobile contracts to improve efficiencies in operation, provide preferred or qualified status to the lender, or otherwise ensure the business success of the two parties. For example, if the lender is able to, or offers to, pay the dealer a certain amount for an automobile contract and such amount is in excess of what the dealer needs to sell the automobile contract for in order to make a profit or even break even on the automobile contract, the dealer may “bank” some or all of the excess and apply it, or use it as a credit for, later sales of one or more automobile contracts to the lender when the lender may only be able to offer less than the dealer's break even point or minimum requirement for an automobile contract. As a more specific example, suppose a dealer selling an automobile contract requires a minimum amount of $1,500.00 for the contract for the dealer to make its minimum acceptable profit. A lender offers $2,000.00 for the contract. Thus, the dealer receives $500.00 in excess of its minimum required amount during the transaction and the lender is able to purchase the automobile contract. The dealer may “bank” or credit the excess amount on behalf of the lender. If, for a contract offered for sale by the dealer to the lender at a later time, the lender is only able to offer an amount less than the dealer's minimum required amount, but within $500.00 of such minimum required amount, the dealer may apply some of the $500.00 in “banked” or credit excess from the previous transaction to the current transaction. For example, suppose during a second transaction the dealer requires a minimum amount of $1,250.00 for an automobile contract but the lender can only offer $1,000.00. The lender and/or dealer may apply $250.00 or more of the “banked” excess from the earlier transaction to the second transaction to allow the adjusted lender amount to be in excess of $1,250.00 (i.e., the minimum amount required by the dealer). Thus, a result of the aggregate of the two sales of automobile contracts from the dealer to the lender is that both the lender and the dealer meet their requirements and the dealer is able to sell both automobile contracts to the lender. Such an approach may allow the dealer and the lender to work together more efficiently and more often, thereby potentially increasing the long-term business success of both parties. In some embodiments, a maximum amount of “banked” amounts may be established such that the lender is limited in how much of the total “banked” amount available is usable for any specific bid made by the lender for a contract.

A dealer and lender may establish filters so that the lender will receive information regarding automobile contracts offered for sale by the dealer and/or so that the dealer will not exclude the lender from bidding on the automobile contracts. In some situations, the dealer may establish a filter such that all other lenders are prevented from bidding on an automobile contract until the lender has had an opportunity to make a bid.

As shown the by the examples of the previous paragraph, in some embodiments, one or more of the methods disclosed herein may include one or more of the following: determining a minimum required amount for purchase of an automobile contract; receiving a bid from a lender for the contract in excess of the minimum required amount for the contract and crediting at least some of the excess for use by the lender for purchase of a second contract for purchase of an automobile; determining a minimum required amount for purchase of a second contract; receiving a bid from the lender for the second contract that is less than the minimum required amount established for the second contract and applying at least some of excess from the first contract to the bid from the lender for the second contract, etc. In some embodiments, any of the methods disclosed herein may include determining a minimum required amount for purchase of an automobile contract and determining an excess over the minimum required amount provided by a winning bid for the contract and crediting a lender associated with the winning bid at least some of the excess for use with a bid provided by the lender for a second or different contract for a purchase of automobile.

### System

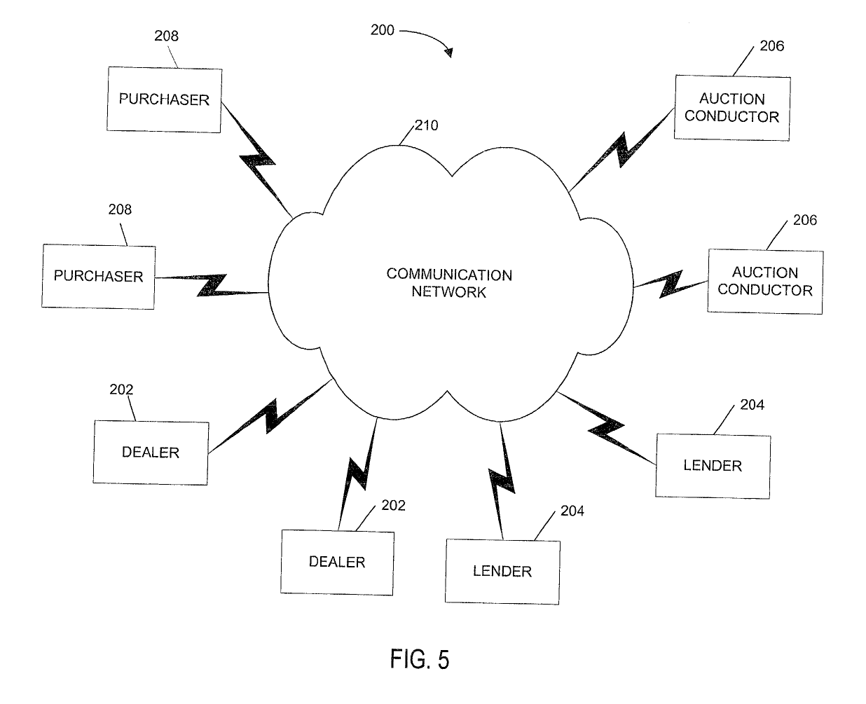

Now referring to FIG. 5, an apparatus or system 200 usable with the methods disclosed herein is illustrated. The apparatus 200 includes one or more dealer devices 202, one or more lender devices 204, one or more auction conductor devices 206, and one or more purchaser devices 208 that may communicate directly or indirectly with each other via a computer, peer-to-peer, data, or other communications network 210. For purposes of further discussion, the terms “dealer” and “dealer device” will be used interchangeably. Similarly, the terms “lender” and “lender device” will be used interchangeably.

In some embodiments, a dealer device 202, a lender device 204, an auction device 206 and/or a purchaser device 208 may be or include a single device or computer, a networked set or group of devices or computers, a server, a workstation, a user or client device, etc.

A dealer device 202 preferably allows a dealer to access or communicate with other devices or entities connected to the communication network 210. For example, a dealer and an automobile purchaser may communicate via email messages transmitted via the communications network 210. A dealer device 202 may be a server, computer or other device and may implement or host a Web site and/or database. In some embodiments, a dealer device 202 may be one of the types of purchaser devices listed below. A dealer device 202 may be used to determine contract parameters and forward them to an auction conductor 206 or a lender 204. Moreover, a dealer device 202 may receive bids, auction status, and other information from lenders and/or auction conductors and purchase or less inquiries or requests from interested customers or other parties.

A lender device 204 preferably allows a lender to access or communicate with other devices or entities connected to the communication network 210. A lender device 204 may be a server, computer or other device and may implement or host a Web site and/or database. In some embodiments, a lender device 204 may be one of the types of purchaser devices listed below. A lender device 204 may be used to receive contract parameters and information regarding contracts available for purchase, to made bids on contracts, and forward them to an auction conductor 206 or a dealer 202. Moreover, a lender device 204 may send and receive information regarding bids, auction status, and other information from lenders, dealers and/or auction conductors.

An auction conductor device 206 preferably allows an auction conduct to access or communicate with other devices or entities connected to the communication network 210. An auction conductor device 206 may be a server, computer or other device and may implement or host a Web site and/or database. In some embodiments, an auction conductor device 206 may be one of the types of purchaser devices listed below. An auction conductor device 206 may be used to receive contract parameters and information regarding contracts available for purchase, to receive bids on contracts, to determine winning bids, and to communicate with dealers, lenders, etc. regarding auctions, bids, etc.

The purchaser, user or client devices 208 preferably allow people to interact with the apparatus 200. For example, a purchaser or user device 208 preferably allows a person shopping for or purchasing an automobile to communicate with one or more dealers, to surf the Web looking for information, etc. The purchaser devices 208 also may enable a user to access Web sites, software, databases, etc. hosted or operated by the devices of the system 200. If desired, a purchaser device 208 also may be connected to or otherwise in communication with other devices. Possible purchaser devices include a personal computer, server, portable computer, mobile or fixed user station, workstation, network terminal or server, cellular telephone, kiosk, dumb terminal, personal digital assistant, etc. In some embodiments, information regarding one or more purchaser and/or one or more user devices may be stored in, or accessed from, a purchaser information database and/or a device information database.

Many different types of implementations or hardware configurations can be used in the system 200 and with the methods disclosed herein and the methods disclosed herein are not limited to any specific hardware configuration for the system 200 or any of its components.

The communications network 210 might be or include the Internet, the World Wide Web, or some other public or private computer, cable, telephone, client/server, peer-to-peer, or communications network or intranet, as will be described in further detail below. The communications network 210 illustrated in FIG. 5 is meant only to be generally representative of cable, computer, telephone, peer-to-peer or other communication networks for purposes of elaboration and explanation of the present invention and other devices, networks, etc. may be connected to the communications network 210 without departing from the scope of the present invention. The communications network 210 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, two or more devices may be connected directly to each other departing from the scope of the present invention. Moreover, as used herein, communications include those enabled by wired or wireless technology.

In some embodiments, a suitable wireless communication network 210 may include the use of Bluetooth technology, allowing a wide range of computing and telecommunication devices to be interconnected via wireless connections. Specifications and other information regarding Bluetooth technology are available at the Bluetooth Internet site www.bluetooth.com. In embodiments utilizing Bluetooth technology, some or all of the devices of FIG. 5 may be equipped with a microchip transceiver that transmits and receives in a previously unused frequency band of 2.45 GHz that is available globally (with some variation of bandwidth in different countries). Connections can be point-to-point or multipoint over a current maximum range of ten (10) meters. Embodiments using Bluetooth technology may require the additional use of one or more receiving stations to receive and forward data from individual devices

Although two dealer devices 202, two lender devices 204, two auction conductor devices 206 and two purchaser devices 208 are shown in FIG. 5, any number of such devices may be included in the system 200. The devices shown in FIG. 5 need not be in constant communication. For example, dealer device 202 may communicate with a lender device 204 or a purchaser device 208 only when such communication is appropriate or necessary.

### Dealer Device

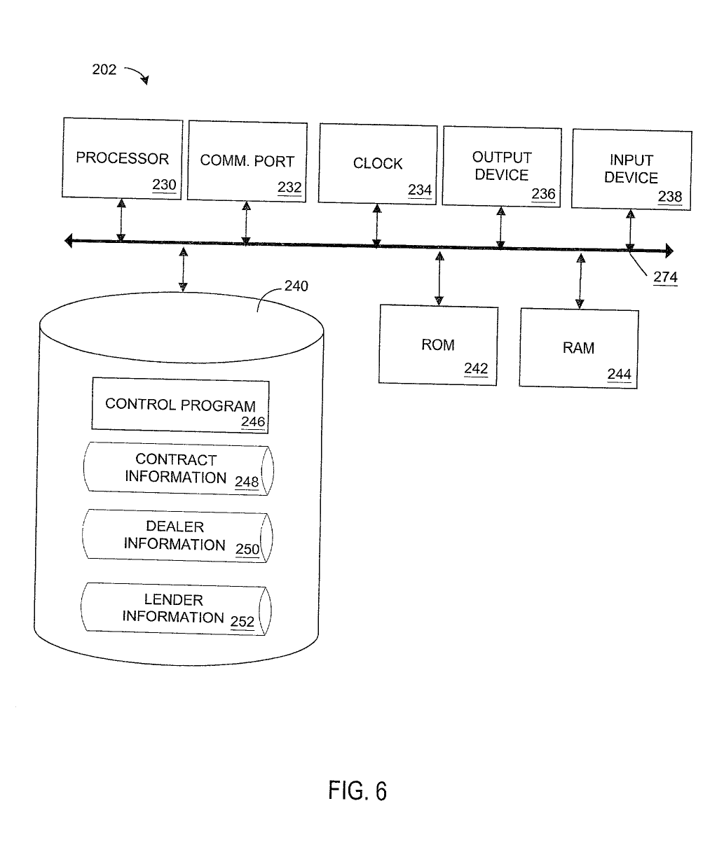

Now referring to FIG. 6, a representative block diagram of a dealer device 202 is illustrated. The dealer device 202 may include a processor, microchip, central processing unit, controller or computer 230 that is in communication with or otherwise uses or includes one or more communication ports 232 for communicating with other devices. Communication ports may include such things as local area network adapters, wireless communication devices, Bluetooth technology, etc. The dealer device 202 also may include an internal clock element 234 to maintain an accurate time and date for the dealer device 202, create time stamps for communications received or sent by the dealer device 202, etc.

If desired, the dealer device 202 may include one or more output devices 236 such as a printer, infrared or other transmitter, antenna, audio speaker, display screen or monitor, text to speech converter, etc., as well as one or more input devices 238 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the dealer device 202 may include a memory or data storage device 240 to store information, software, databases, communications, device drivers, bids, contracts, etc. The memory or data storage device 240 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The dealer device 202 also may include separate ROM 242 and RAM 244.

The processor 220 and the data storage device 240 in the dealer device 202 each may be, for example: (i) located entirely within a single computer or other computing device; or (ii) connected to each other by a remote communication medium, such as a serial port cable, telephone line or radio frequency transceiver. In one embodiment, the dealer device 202 may comprise one or more computers that are connected to a remote server computer for maintaining databases.

A conventional personal computer, server or workstation with sufficient memory and processing capability may be used as the dealer device 202. In one embodiment, the dealer device 202 operates as or includes a Web server for an Internet environment. The dealer device 202 preferably is capable of high volume transaction processing, performing a significant number of mathematical calculations in processing communications and database searches. A Pentium™ microprocessor such as the Pentium III™ microprocessor, manufactured by Intel Corporation may be used for the processor 230. Equivalent processors are available from Motorola, Inc., AMD, or Sun Microsystems, Inc. The processor 230 also may comprise one or more microprocessors, computers, computer systems, etc.

Software may be resident and operating or operational on the dealer device 202. The software may be stored on the data storage device 240 and may include a control program 246 for operating the dealer device 202, databases, etc. The control program 246 may control the processor 230. The processor 230 preferably performs instructions of the control program 236, and thereby operates in accordance with the present invention, and particularly in accordance with the methods described in detail herein. The control program 236 may be stored in a compressed, uncompiled and/or encrypted format. The control program 246 furthermore includes program elements that may be necessary, such as an operating system, a database management system and device drivers for allowing the processor 230 to interface with peripheral devices, databases, etc. Appropriate program elements are known to those skilled in the art, and need not be described in detail herein.

The dealer device 202 also may include, access or store information regarding dealers, lenders, auctions, contracts, bids, automobiles, communications, etc. For example, information regarding one or more contracts may be stored in a contract information database 248 for use by the dealer device 202 or another device or entity. Information regarding one or more dealers may be stored in a dealer information database 250 for use by the dealer device 202 or another device or entity and information regarding one or more lenders may be stored in a lender information database 252 for use by the dealer device 202 or another device or entity. In some embodiments, one or more of the databases may be stored or accessed remotely. In some embodiments, the dealer device 202 or another device may maintain, store, update, access, etc. a purchaser information database that includes information regarding one or more actual or potential automobile purchasers, an automobile information database that includes information regarding one or more automobiles, an auction conductor information database that includes information regarding one or more auction conductors, etc. In some embodiments, one or more of the databases may be stored or accessed remotely.

According to an embodiment of the present invention, the instructions of the control program may be read into a main memory from another computer-readable medium, such as from the ROM 242 to the RAM 244. Execution of sequences of the instructions in the control program causes the processor 220 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 230, communication port 232, clock 234, output device 236, input device 238, data storage device 240, ROM 242, and RAM 244 may communicate or be connected directly or indirectly in a variety of ways. For example, the processor 230, communication port 232, clock 234, output device 236, input device 238, data storage device 240, ROM 242, and RAM 244 may be connected via a bus 260.

While specific implementations and hardware configurations for dealer devices 202 have been illustrated, it should be noted that other implementations and hardware configurations are possible and that no specific implementation or hardware configuration is needed. Thus, not all of the components illustrated in FIG. 5 may be needed for a dealer device implementing the methods disclosed herein. Therefore, many different types of implementations or hardware configurations can be used in the system 200 and the methods disclosed herein are not limited to any specific hardware configuration.

### Lender Device

As mentioned above, a lender device 204 may be or include any of a number of different types of devices, including, but not limited to a personal computer, portable computer, mobile or fixed user station, workstation, network terminal or server, etc. In some embodiments, a lender device 204 may host or implement a Web site. In some embodiments, a lender device 204 may have the same structure or configuration as the dealer device 202 illustrated in FIG. 6 and include some or all of the components of the dealer device 202.

### Auction Conductor Device

As mentioned above, an auction conductor device 206 may be or include any of a number of different types of devices, including, but not limited to a personal computer, portable computer, mobile or fixed user station, workstation, network terminal or server, etc. In some embodiments, an auction conductor device 206 may host or implement a Web site. In some embodiments, an auction conductor device 206 may have the same structure or configuration as the dealer device 202 illustrated in FIG. 6 and include some or all of the components of the dealer device 202.

### Purchaser Device

As mentioned above, a purchaser device 208 may be or include any of a number of different types of devices, including, but not limited to a personal computer, portable computer, mobile or fixed user station, workstation, network terminal or server, telephone, beeper, kiosk, dumb terminal, personal digital assistant, facsimile machine, two-way pager, radio, cable set-top box, etc. In some embodiments, a purchaser device 208 may have the same structure or configuration as the dealer device 202 illustrated in FIG. 6 and include some or all of the components of the dealer device 202.

### Databases

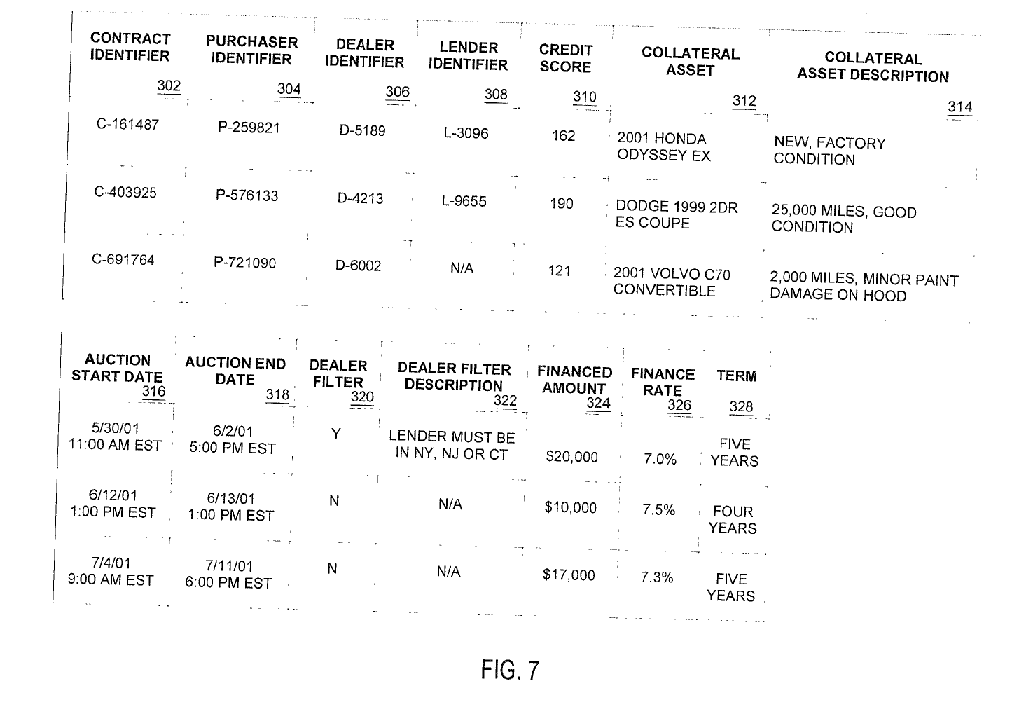

As previously discussed above, in some embodiments a dealer device 202, lender device 204, auction device 206 or some or other device may include or access a contract information database for storing or keeping information regarding one or more contracts. One representative contract information database 300 is illustrated in FIG. 7.

In some embodiments, the contract information database 300 may include a contract identifier field 302 that may include codes or other identifiers for one or more contracts that have been sold via auction, will be sold via auction, or are currently available for sale or bidding via auction, a purchaser identifier field 304 that may include codes or other identifiers for actual or potential purchasers, if any, associated with the contracts identified in the field 302, a dealer identifier field 306 that may include codes or other identifiers for one or more dealers associated with the contracts identified in the field 302, and a lender identifier field 306 that may include codes or other identifiers for one or more lenders, if any, associated with the contracts identified in the field 302 (e.g., lenders that purchased the contracts identified in the field 302 or won the right to purchases the contracts via auction).

In some embodiments, the contract information database 300 also may include a credit score field 310 that may include credit information (e.g., FICO scores), credit reports, financing applications, and/or other data associated with the contracts identified in the field 302, purchasers identified in the field 304, etc. A collateral asset field 312 may include information and other data (e.g., a vehicle identification (VIN) number) regarding an automobile sold or being sold by a dealer or otherwise associated with a contract identified in the field 302. A collateral asset description field 314 may include information regarding the condition, quality, etc. of the collateral asset identified in the field 312.

Since the contracts identified in the field 302 presumably are being offered for sale via auction by a dealer or another party on behalf of the dealer, in some embodiments the contract information database 300 may include an auction start date field 316 and an auction end date field 318 that contain information regarding start and end dates respectfully for auctions of the contracts identified in the field 302. A dealer filter field 320 may indicate whether or not a dealer filter has, should, or will be applied to the contracts identified in the field 302 and a dealer filter description field 322 may include specific information and details regarding the dealer filters to be applied, if any.

In some embodiments, the contract information database 300 also may include information regarding a financed amount, interest rate, and financing or payment term associated with the contracts identified in the field 302, as illustrated by the fields 324, 326 and 328, respectfully, in the contract information database 328.

Other or different fields also may be used in the contract information database 300. For example, the contract information database 300 may include a field that contains information regarding the equity position of the collateral asset and/or the purchaser in relation to the collateral asset, a field that contains information regarding the purchase price for the collateral asset, a field that contains additional information (e.g., occupation, residence, income level, length of time in current residence, length of time in current occupation) regarding the purchaser of the automobile, a field that contains information regarding minimum bid requirements, a field that contains information regarding lender filters that may or have been applied with regard to a contract identified in the field 302, a field that contains information regarding number or nature of bids received for a contract identified in the field 302, a field that contains information regarding a winning bid for a contract identified in the field 302, etc.

As illustrated by the contract information database 300 of FIG. 7, the contract identified as “C-161487” in the field 302 is associated with a purchaser identified as “P-259821”, a dealer identified as “D-5189” and a lender identified as “L-3096”. In some embodiments, information regarding one or more purchasers may be stored in or accessed from a purchaser information database, information regarding one or more dealers may be stored in or access from a dealer information database, and/or information regarding one or more lenders may be stored in or accessed from a lender information database.

The purchaser identified as “P-259821” has a credit score of “162” is purchasing a “2001 HONDA ODYSSEY EX” with is in “NEW, FACTORY CONDITION.” An auction for the contract “C-161487” started on May 30, 2001, at 11:00 PM EST and ended on Jun. 2, 2001, at 5:00 PM EST. A dealer filter was applied to the auction that required that lenders bidding on the contract “C-161487” be located in New York, New Jersey or Connecticut. Presumably the lender identified as “L-3096” meets this dealer filter requirement and won the auction for the contract “C-161487”. The contract “C-161487” includes a five-year financing of twenty thousand dollars and includes an annual interest rate of seven percent.

As illustrated by the contract information database of FIG. 7, the contracts identified as “C-161487” and “C-403925” in the field 302 have been auctioned and sold to the lenders identified as “L-3096” and “L-9655”, respectfully, while the contract identified as “C-691764” in the field 302 has not yet been sold.

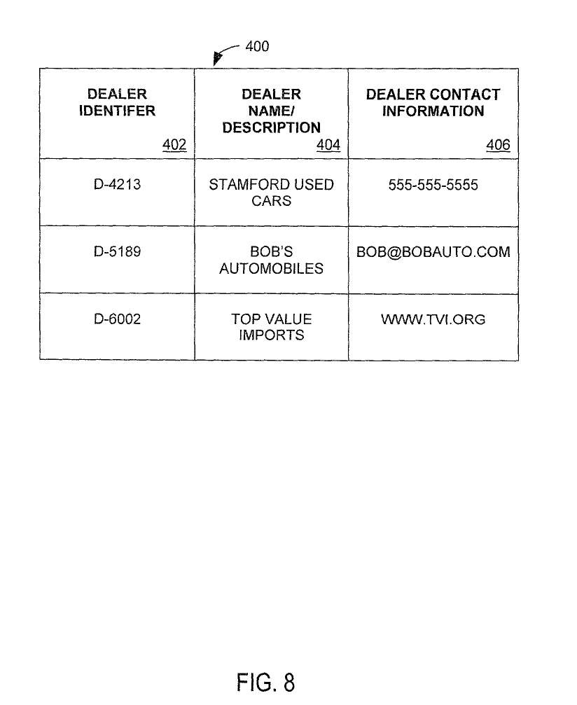

As previously discussed above, in some embodiments a dealer device 202, lender device 204, auction device 206 or some or other device may include or access a dealer information database for storing or keeping information about regarding one or more dealers. One representative dealer information database 400 is illustrated in FIG. 8.

The dealer information database 400 may include a dealer identifier field 402 that may include codes or other identifiers for one or more dealers, a dealer name or description field 404 that may include names or other descriptive information for the dealers identified in the field 402, and a dealer contact information field 406 that may include telephone numbers, postal or email addresses, contact names or other contact information for the dealers identified in the field 402. Other or different fields also may be used in the dealer information database 400. For example, in some embodiments, the dealer information database 400 may include information regarding contracts sold by a dealer identified in the field 402, information regarding contracts available for bid from or by a dealer identified in the field 402, information regarding a filter applicable or associated with a dealer identified in the field 402, information regarding a minimum bid requirement associated with a dealer identified in the field 402, etc.

As illustrated by the dealer information database 400 of FIG. 8, a dealer identified as “D-4213” in the field 402 is named “STAMFORD USED CARS” and can be contacted at the telephone or facsimile number “555-555-5555”. The dealer identified as “D-5189” in the field 402 is named “BOB'S AUTOMOBILES” and can be contacted via the email address “BOB@BOBAUTO.COM”.

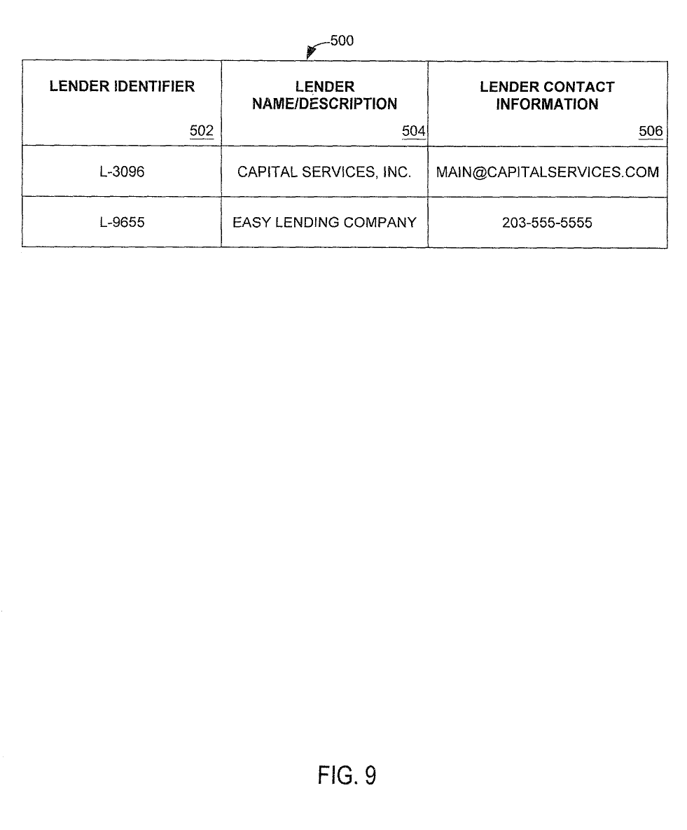

As previously discussed above, in some embodiments a dealer device 202, lender device 204, auction device 206 or some or other device may include or access a lender information database for storing or keeping information regarding one or more lenders. One representative lender information database 500 is illustrated in FIG. 9.

The lender information database 500 may include a lender identifier field 502 that may include codes or other identifiers for one or more lenders, a lender name or description field 504 that may include names or other descriptive information for the lenders identified in the field 502, and a lender contact information field 506 that may include telephone numbers, postal or email addresses, contact names or other contact information for the lenders identified in the field 502. Other or different fields also may be used in the lender information database 500. For example, in some embodiments, the lender information database 500 may include information regarding contracts purchased or bid on by a lender identified in the field 502, information regarding a filter applicable or associated with a lender identified in the field 502, etc.

As illustrated by the lender information database 500 of FIG. 9, a lender identified as “L-43096” in the field 502 is named “CAPITAL SERVICES, INC.” and can be contacted via the email address MAIN@CAPITALSERVICES.COM. The lender identified as “L-9655” in the field 502 is named “EASY LENDING COMPANY” and can be contacted via the telephone or facsimile number “203-555-5555”.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to several embodiments, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

What is claimed is:

1. A method for clearing an automobile contract, comprising: determining at least one parameter for a contract associated with financing provided by a first party to a second party regarding an automobile;
auctioning said contract such that first party sells said contract; and
notifying at least one party of a winning bid for said contract.

2. The method of claim 1, wherein said determining at least one parameter for a contract includes at least one of the following:
establishing a default set of contract parameters; and
receiving data indicative of said at least one parameter.

3. The method of claim 1, wherein said determining at least one parameter for a contract includes at least one of the following:
receiving said at least one parameter from a dealer;
receiving said at least one parameter from a potential lessee of said automobile;
receiving said at least one parameter from an actual lessee of said automobile;
receiving said at least one parameter from a potential purchaser of said automobile; and
receiving said at least one parameter from an actual purchaser of said automobile.

4. The method of claim 1, wherein said determining at least one parameter for a contract includes at least one of the following:
determining a condition of said automobile; and
determining information regarding said automobile.

5. The method of claim 1, wherein said determining at least one parameter for a contract includes at least one of the following:
determining an equity position in said automobile by a purchaser of said automobile.

6. The method of claim 1, wherein said determining at least one parameter for a contract includes at least one of the following:
determining a payment stream associated with said financing.

7. The method of claim 1, wherein said auctioning said contract includes:
providing a notification of said at least one parameter to a conductor of an auction for said contract; and
receiving information regarding a winning bid for said contract from said conductor of said auction for said contract.

8. The method of claim 1, wherein said auctioning said contract includes at least one of the following:
applying at least one filter imposed by a lender; and
applying at least one filter imposed by a dealer.

9. The method of claim 1, wherein said auctioning said contract includes at least one of the following:
receiving information regarding at least one filter imposed by a lender; and
receiving information regarding at least one filter imposed by a dealer.

10. The method of claim 1, wherein said auctioning said contract includes:
notifying a plurality of lenders regarding said contract and said at least one parameter; and
receiving at least one bid from at least one of said plurality of lenders.

11. The method of claim 10, wherein said auctioning said contract includes:
identifying a winning bid from said at least one bid received from said at least one of said plurality of lenders.

12. The method of claim 1, wherein said auctioning said contract includes at least one of the following:
notifying a dealer regarding said lender's winning an auction for said contract
notifying a lender regarding said lender's winning an auction for said contract;
notifying a lessee of said automobile regarding a lender for said contract; and
notifying a purchaser of said automobile regarding a lender for said contract.

13. The method of claim 1, wherein said auctioning said contract includes receiving at least one bid for said contract.

14. The method of claim 1, wherein said notifying at least one party of a winning bid for said contract includes at least one of the following:
notifying a dealer selling said automobile regarding a lender for said contract;
notifying a lender regarding said lender's winning an auction for said contract; and
notifying a purchaser of said automobile regarding a lender for said contract.

15. The method of claim 1, further comprising at least one of the following:
receiving data indicative of a dealer filter; and
receiving data indicative of a lender filter.

16. The method of claim 1, further comprising at least one of the following:
sending data indicative of a dealer filter; and
sending data indicative of a lender filter.

17. The method of claim 1, wherein said auctioning said contract includes providing information to a conductor of an auction for said contract.

18. The method of claim 17, wherein said information includes said at least one parameter.

19. The method of claim 1, wherein said determining at least one parameter for a contract includes determining at least one parameter for a first contract for sale of a first automobile and at least one parameter for a second contract for sale of a second automobile.

20. The method of claim 19, wherein said auctioning said contract includes auctioning a pool that includes said first contract and said second contract.

21. The method of claim 20, wherein said notifying at least one party of a winning bid for said contract includes notifying said at least one party of a winning bid for said pool.

22. The method of claim 1, wherein said at least one contract parameter includes information regarding said automobile.

23. The method of claim 1, further comprising:
determining a minimum required amount for purchase of said contract.

24. The method of claim 23, further comprising:
receiving a bid from a lender for said contract in excess of said minimum required amount for said contract and crediting at least some of said excess for use by said lender for purchase of a second contract for purchase of an automobile.

25. The method of claim 24, further comprising:
determining a minimum required amount for purchase of said second contract; and
receiving a bid from said lender for said second contract that is less than said minimum required amount for said second contract and applying at least some of said excess to said bid from said lender for said second contract.

26. The method of claim 1, further comprising:
selling said contract in accordance with said winning bid.

27. The method of claim 1, further comprising:
receiving payment for said contract in accordance with said winning bid.

28. The method of claim 1, wherein said first party is selling said automobile to said second party.

29. The method of claim 1, wherein said contract is executed between said first party and said second party.

30. A method for clearing an automobile contract, comprising:
receiving data from a party, said data being indicative of at least one parameter associated with an automobile contract;
auctioning said automobile contract; and
notifying said party of a wining bid for said automobile contract.

31. The method of claim 30, wherein said party is a dealer.

32. The method of claim 30, wherein said automobile contract regards financing for an automobile.

33. The method of claim 30, wherein said automobile contract involves a lease of an automobile.

34. The method of claim 30, further comprising:
notifying a lender associated with said winning bid that said lender has won an auction for said automobile contract.

35. The method of claim 30, further comprising:
notifying a plurality of lenders regarding an auction for said automobile contract.

36. The method of claim 35, wherein said winning bid is received from one of said plurality of lenders.

37. The method of claim 30, wherein said auctioning said automobile contract includes at least one of the following:
applying a dealer filter; and
applying a lender filter.

38. The method of claim 30, wherein said receiving data from a party, said data being indicative of at least one parameter for an automobile contract for an automobile includes receiving said data from said party wherein said data is indicative of at least one parameter for a first automobile contract for a first automobile and at least one parameter for a second automobile contract associated with a second automobile.

39. The method of claim 38, wherein said auctioning said automobile contract includes auctioning a pool that includes said first automobile contract and said second automobile contract.

40. The method of claim 39, wherein said notifying said party of a winning bid for said automobile contract includes notifying said party of a winning bid for said pool.

41. The method of claim 30, wherein said at least one contract parameter includes information regarding an automobile associated with said automobile contract.

42. The method of claim 30, further comprising:
determining a minimum required amount for purchase of said automobile contract; and
receiving a bid from a lender for said automobile contract in excess of said minimum required amount for said automobile contract and crediting at least some of said excess for use by said lender for purchase of a second automobile contract.

43. The method of claim 42, further comprising:
determining a minimum required amount for purchase of said second automobile contract; and
receiving a bid from said lender for said second automobile contract that is less than said minimum required amount for said second automobile contract and applying at least some of said excess to said bid from said lender for said second automobile contract.

44. A method for clearing an automobile contract, comprising:
determining at least one parameter for at least one automobile contract;
applying at least one dealer filter;
providing a notification to at least one lender regarding an opportunity to bid on said at least one automobile contract, wherein said notification includes data indicative of said at least one parameter for said at least one automobile contract;
receiving a bid from said at least one lender regarding said at least one automobile contract; and
determining a winning bid for said at least one automobile contract.

45. The method of claim 44, wherein said at least one parameter includes at least one of the following:
information regarding quality of an automobile associated with said automobile contract; and
information regarding a purchaser's equity position in an automobile associated with said automobile contract.

46. The method of claim 44, further comprising:
determining a minimum required amount for purchase of said automobile contract; and
determining an excess over said minimum required amount provided by said winning bid and crediting a lender associated with said winning bid at least some of said excess for use with a bid provided by said lender for a second automobile contract.

47. The method of claim 44, wherein said at least one parameter includes information regarding an automobile associated with said automobile contract.

48. The method of claim 44, wherein said providing a notification to at least one lender regarding an opportunity to bid on said at least one automobile contact includes displaying information regarding said automobile contract on a Web site and allowing said lender to access said information.

49. The method of claim 44, wherein said automobile contract provides financing for an automobile.

50. The method of claim 44, wherein said automobile contract involves a lease of an automobile.

51. A method for selling an automobile contract, comprising:
receiving at least one parameter for at least one automobile contract;
applying at least one lender filter;
providing a notification to at least one lender regarding an opportunity to bid on said at least one automobile contract, wherein said notification includes data indicative of said at least one parameter;
receiving a bid from said at least one lender regarding said at least one automobile contract;
determining a winning bid for said at least one automobile contract; and
notifying at least one party regarding said winning bid.

52. The method of claim 51, wherein said at least one parameter includes at least one of the following:
information regarding quality of an automobile associated with said automobile contract; and
information regarding a purchaser's equity position in an automobile associated with said automobile contract.

53. The method of claim 51, further comprising:
determining a minimum required amount for purchase of said automobile contract; and
determining an excess over said minimum required amount provided by said winning bid and crediting a lender associated with said winning bid at least some of said excess for use with a bid provided by said lender for a second automobile contract.

54. The method of claim 51, wherein said at least one parameter includes information regarding an automobile associated with said automobile contract.

55. The method of claim 51, wherein said providing a notification to at least one lender regarding an opportunity to bid on said at least one automobile contact includes displaying information regarding said contract on a Web site and allowing said lender to access said information.

56. A system for facilitating clearance of automobile contracts, comprising:
a memory;
a communication port; and
a processor connected to said memory and said communication port, said processor being operative to:
determine at least one parameter for a contract associated with an automobile contract;
auction said automobile contract; and
notify at least one party of a winning bid for said automobile contract.

57. The system of claim 56, wherein said processor is further operative to:
determine a minimum required amount for purchase of said automobile contract; and
determine an excess over said minimum required amount provided by said winning bid and crediting a lender associated with said winning bid at least some of said excess for use with a bid provided by said lender for a second automobile contract.

58. A computer program product in a computer readable medium for facilitating clearance of automobile contracts, comprising:
first instructions for identifying at least one parameter for an automobile contract;
second instructions for placing said automobile contract for auction; and
third instructions for providing a notification to at least one party of a winning bid for said automobile contract.

59. The computer program product of claim 58, further comprising:
fourth instructions for filtering lenders that can bid on said automobile contract.

60. The computer program product of claim 58, further comprising:
fourth instructions for identifying a minimum required amount f or purchase of said automobile contract; and
fifth instructions for identifying an excess over said minimum required amount provided by said winning bid and crediting a lender associated with said winning bid at least some of said excess for use with a bid provided by said lender for a second automobile contract.
